(19) United States
(12) Patent Application Publication
(10) Pub. No.: US 2013/0220948 A1
(43) Pub. Date: Aug. 29, 2013

(54) NAIL POLISH DISPLAY DEVICE

(71) Applicant: Cuong Nguyen, Seattle, WA (US)

(72) Inventor: Cuong Nguyen, Seattle, WA (US)

(21) Appl. No.: 13/594,581

(22) Filed: Aug. 24, 2012

Related U.S. Application Data
(60) Provisional application No. 61/526,911, filed on Aug. 24, 2011.

(51) Int. Cl. A47F 3/11; B01F 13/08; B01F 11/02; B65D 25/20

(52) U.S. Cl. CPC A47F 3/11; B65D 25/20; B01F 13/08; B01F 11/0266
USPC 211/1.55; 215/386; 366/273; 366/111

(57) ABSTRACT

A nail polish display system includes a case, which may take the form of a shelving system or platform, sized to hold and display multiple bottles of nail polish. The bottles are placed on rollers, vibration generating pads, or placed in vicinity of a magnetic disc or rod. A motor operates a drive system for spinning the rollers or magnetic disc/rod, which in turns agitates the liquid nail polish in the bottles. The drive systems may take the form of a gear train system or a pulley system. For the magnetic agitation, the magnetic disc/rod causes ferromagnetic balls within the nail polish bottle to agitate the nail polish. Additionally or alternatively, the nail polish display system may include protective sleeves or covers for the nail polish bottles. Preferably, the sleeves are contoured to permit a brand or color of the nail polish to be adequately visible when the bottles are in the display case.

### PRIORITY CLAIM

This application claims priority from U.S. Provisional Patent Application No. 61/526,911 filed on Aug. 24, 2011, and claims priority from U.S. patent application Ser. No. 13/005,424 and wherein the subject matter of each is incorporated herein by reference in their entireties.

### FIELD OF THE INVENTION

This invention relates generally to a nail polish display system, and more specifically to a nail polish display system operable to continuously agitate nail polish.

### BACKGROUND OF THE INVENTION

Nail polish traditionally comes in clear bottles, which are usually made of glass and may be configured in a variety of shapes and sizes. The nail polish itself may come in many different colors. Regardless of the bottle shape or the polish color, one main objective is to catch the eye of a purchaser. Most often, this objective includes a point-of-sale display of different nail polish colors arranged on a multi-shelf or multi-platform system. For example, a beauty salon may have at least one point-of-sale display with various colors of a particular brand placed on shelves proximate a cashier.

In such a conventional shelving display, the nail polish bottle tends to sit on the shelf until an interested consumer picks up the bottle to better examine its contents. Nail polish, similar to wall paint, is made up of different chemical components having different densities, which means that over time the heavier components (usually related to the specific color of the polish) settle on the bottom of the bottle or at least begin to settle thus causing the ambient light to be perceived differently than if the polish was in a fully mixed state. Accordingly, it is quite common for the interested consumer to pick up the bottle and shake it to see the actual polish color. Quite often, the consumer shakes the bottle and the color changes, which in turn prompts the consumer to pick up and shake another bottle in an attempt to find a desired shade. While the consumer shaking process may appear to achieve the fully mixed state having the actual polish color, it is equally common for the consumer to agitate the bottle too much and cause air bubbles to form in the bottle. In some cases, the over-agitation may cause the bottle to break because manufactures typically insert a small ceramic or glass marble inside the bottle to help mix the polish. Likewise, the marble may also break due to over-agitation.

The air bubbles formed by over-agitation generally make it more difficult to smoothly apply the polish to a fingernail or toenail (hereinafter simply nail). While breakage of the bottle may be less common, breakage of the marble within the bottle leaves marble particulate inside the bottle and some of this particulate may be fine enough to be suspended in the polish. The suspended marble particulate may then be applied to the consumer's nail causing a granular or non-smooth finish.

### BRIEF SUMMARY OF THE INVENTION

A nail polish display system includes a case, which may take the form of a shelving system or platform, sized to hold and display multiple bottles of nail polish. The bottles are attached to coupling devices, such as clamps, sleeves, magnetic couplers, etc. to an agitator, which preferably takes the form of a rotatable rod. A motor operates the agitator to move, rotate or otherwise agitate the bottles and therefore sufficiently and continuously mix the nail polish within the bottles. The system may include one or more sensors configured to detect the presence of a patron, configured to detect a position of the motor or agitator, and/or configured to detect when a door to the case is being opened. Further, the motor may be programmable and receive instructions from either a controller or control logic using input from one or more of the sensors.

In one aspect of the present invention, a nail polish display system includes a plurality of rollers arranged adjacently to one another, each roller having a rolling axis, wherein the rolling axes form a plane, and at least one nail polish bottle contacts two of the rollers; a drive system arranged to rotate the plurality of rollers; and a motor coupled to the drive system, wherein operation of the motor and drive system causes rotation of the rollers, which in turn agitates nail polish within the at least one nail polish bottle.

In another aspect of the present invention, a nail polish display system includes a nail polish bottle having a ball located within the bottle, the ball made from a ferromagnetic material; a non-magnetic support surface in contact with a bottom surface of the nail polish bottle; a rotatable ferromagnetic member located beneath the support surface; a drive system coupled to the ferromagnetic member; and a motor coupled to the drive system, wherein operation of the motor and drive system causes rotation of the ferromagnetic member, which in turn moves the ball within the bottle to agitate the nail polish.

In yet another aspect of the present invention, a protective sleeve for a nail polish bottle includes a back portion substantially covering a majority of a back side of the nail polish bottle; side portions extending around each side of the nail polish bottle; and a front portion extending between the side portions, the front portion configured to permit nearly a full view of the nail polish bottle, wherein the back, side and front portions are configured to define a cavity that closely receives the nail polish bottle.

### BRIEF DESCRIPTION OF THE DRAWINGS

Preferred and alternative embodiments of the present invention are described in detail below with reference to the following drawings.

FIG. 1 is perspective view a nail polish display system having agitators coupled to bottles located within a case according to an embodiment of the present invention;

FIG. 2 is top plan view of the bottom row of bottles from FIG. 1;

FIG. 3 is side, perspective view of a nail polish bottle retained by a coupling device according, to an embodiment of the present invention;

FIG. 4 is a cross-sectional view of the coupling device of FIG. 3 according to an embodiment of the present invention;

FIG. 5 is a perspective view of a nail polish display system having coupling device according to another embodiment of the present invention;

FIG. 6 is a rear perspective view of one of the coupling devices from FIG. 5 connected to a finger nail polish bottle according to an embodiment of the present invention;

FIG. 7 is a perspective view of a nail polish display system having coupling device according to another embodiment of the present invention;

FIG. 8 is a rear perspective view of one of the coupling devices from FIG. 7 connected to a finger nail polish bottle according to an embodiment of the present invention;

FIG. 9 is a perspective view of a nail polish display system according to yet another embodiment of the present invention;

FIG. 10 is a perspective view of a nail polish display system according to still another embodiment of the present invention;

FIG. 11 is a block diagram of a nail polish display system according to an embodiment of the present invention;

FIG. 12 is a block diagram of a nail polish display system according to another embodiment of the present invention;

FIG. 13 is a rear elevational view of a nail polish display system having agitating rollers aligned relative to a horizontal surface according to an embodiment of the present invention;

FIG. 14 is a side elevational view of a nail polish display system having agitating rollers angled relative to a horizontal surface according to an embodiment of the present invention;

FIG. 15 is a schematic view of a drive system for generating rotation of rollers in a finger nail display system according to an embodiment of the present invention;

FIG. 16A is a rear elevational it of a nail polish display system having a pulley drive system according to an embodiment of the present invention;

FIG. 16B is a side elevational view of a rotatable support bracket for a nail polish bottle according to an embodiment of the present invention;

FIG. 16C is a perspective view of the nail polish display system of FIG. 16A with the nail polish bottles in an upright position;

FIG. 16D is a perspective view of the nail polish display system of FIG. 16A with the nail polish bottles at about a forty-five degree position;

FIG. 16E is a perspective view of the nail polish display system of FIG. 16A with the nail polish bottles at about a ninety degree position;

FIG. 17A is a front elevational view of a nail polish display system in which magnetic members are used to agitate the nail polish according to an embodiment of the present invention;

FIG. 17B is a bottom view of a pulley drive system for the nail polish display of FIG. 17A;

FIG. 17C is a side elevational view of nail polish bottle supported on a static platform in proximity to a rotating magnetic disc according to an embodiment of the present invention;

FIG. 18A is a front elevational view of a nail polish display system having vibration generators beneath the nail polish bottles according to an embodiment of the present invention;

FIG. 18B is a perspective of the nail polish display system of FIG. 18A; and

FIG. 19 is a side devotional view of a protective sleeve for a nail polish bottle according to an embodiment of the present invention.

### DETAILED DESCRIPTION OF THE INVENTION

The present invention generally relates, but is not limited, to a nail polish display system configured to rotate or otherwise agitate bottles of nail polish to maintain the polish in a sufficiently mixed state. In at least one embodiment, the nail polish display system includes a display case with agitators that hold one or more bottles of nail polish. The agitators and bottles may be arranged in a variety of configurations. A programmable motor may be used to drive the agitators, which may take the form of rotating members driven at a desired angular velocity. Coupling assemblies attached to the agitators may either support or clasp to the bottles. In one embodiment, the display case includes a touch or proximity sensor that signals the motor to stop when someone opens a door of the case, reaches inside the case, or makes some other detectable action to indicate that they want to handle one of the bottles of finger nail polish. Upon receiving such a signal either from the sensor or by way of a remote control, the motor may be commanded to move the agitators and thus position the bottles in a desired orientation, for example position the bottles oriented cap side up.

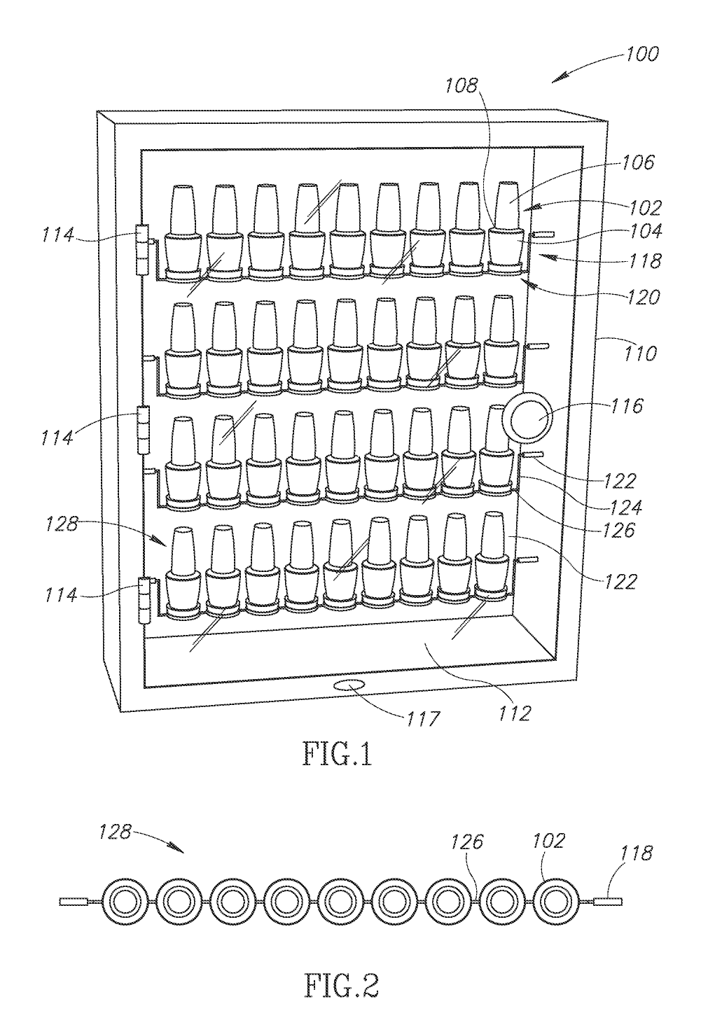

FIG. 1 shows a nail polish display system 100 for a plurality of bottles 102, each preferably containing a different color of nail polish (not shown). Each bottle 102 includes a polish-holding portion 104 and a cap portion 106, the latter typically being threaded onto the polish-holding portion 104. The bottle 102 may also include a neck portion 108. The bottles 102 are located generally within a case 110, which may have a transparent door 112 hingedly 114 attached to the case 110 according to one embodiment. A handle 116 may be coupled to the door 112 or the door may be spring and/or magnetically actuated to open and shut by pressing on the door 102. A sensor 117 may be located on a front of the case 110. The sensor 117 may take the form of a touch sensor, a proximity sensor or some other device capable of detecting the presence of a person in front of the case 110.

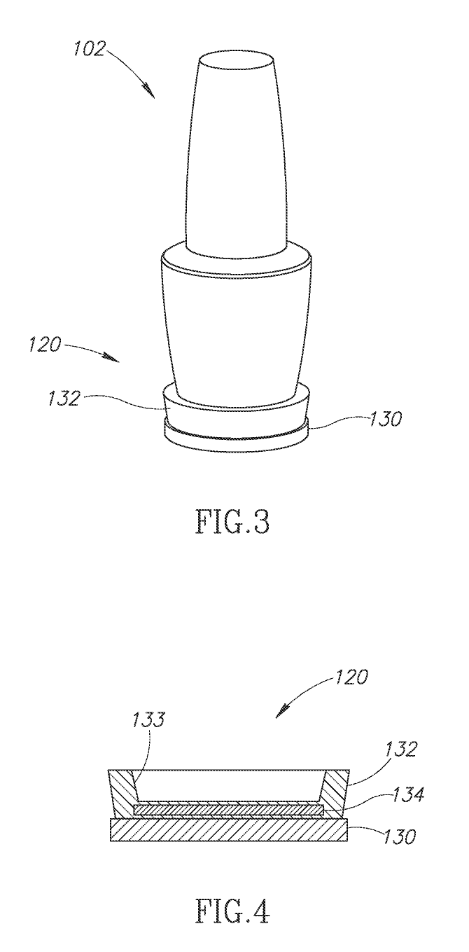

An agitator 118 coupled the case 110 may take the form of a rotatable rod attached to bottle-coupling assemblies 120. In the illustrated embodiment, the agitators 118 include a drive arm 122, an offset arm 124 and a bottle-support portion 126. FIG. 2 shows a top, plan view of the bottles 102 arranged in a lower row 128 of the case 110 of FIG. 1, but with the case structure removed for purposes of clarity.

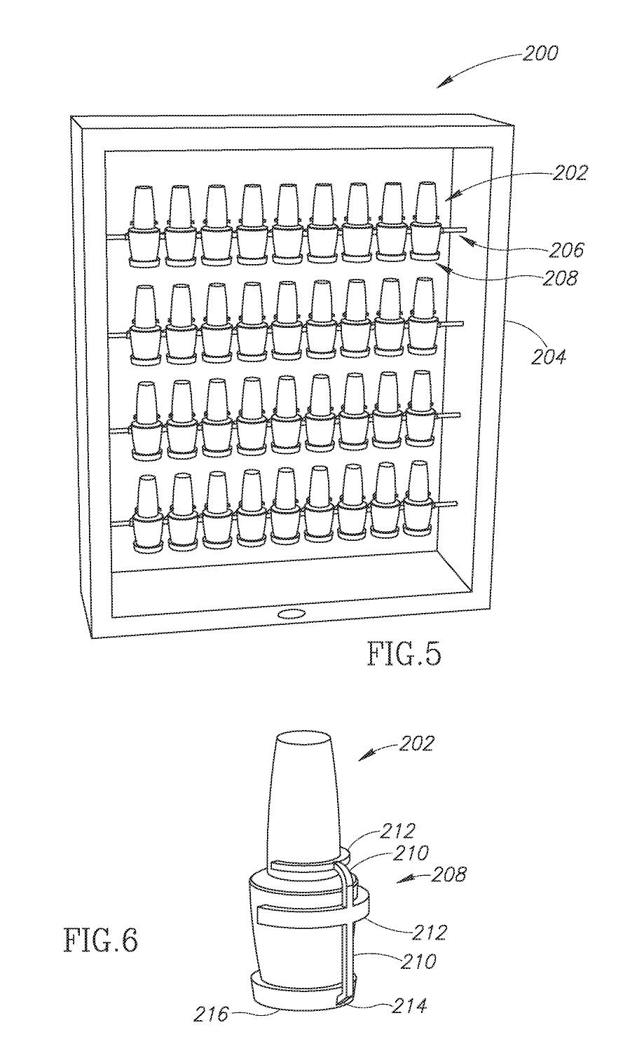

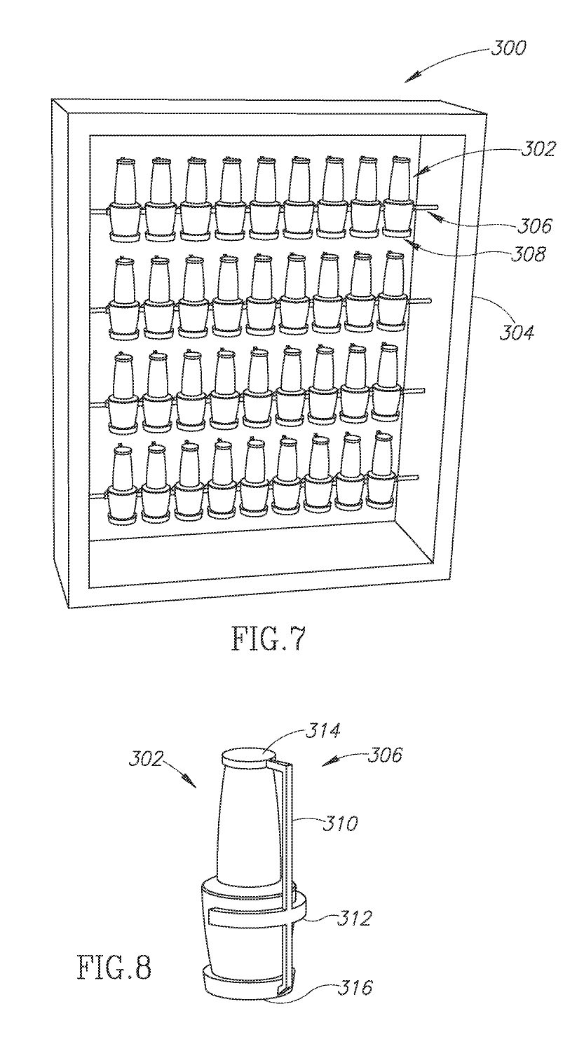

FIGS. 3 and 4 show the bottle-coupling assembly 120 according to an embodiment of the present invention. The assembly 120 includes a base member 130 connectable to a sleeve member 132. The base member 130 is fixed to the agitator 118. In the illustrated embodiment, the sleeve member 132 is configured to closely receive the bottle 102. The sleeve member 132 may include an elastomeric, foam or synthetic liner, insert or seal 133 that suctions to the bottle 102. In addition, the sleeve member 132 may include a magnetic plug 134 preferably embedded into the sleeve member 132. Alternatively, the sleeve member 132 itself may be made from an iron-based substance and thus be magnetizable. Similarly, the base member 130 may also be made from a magnetizable material or include a magnetizable plug (not shown). In use, an interested person would select and remove a bottle 102 from the case 110 and the sleeve member 132 would stay attached to the bottle 102. The person could examine the bottle 102; sample its contents, etc. Upon placing the bottle 102 back in the case 110, the magnetic attraction between the base member 130 and sleeve member 132 would urge the bottle 102 back into place on the agitator 118.

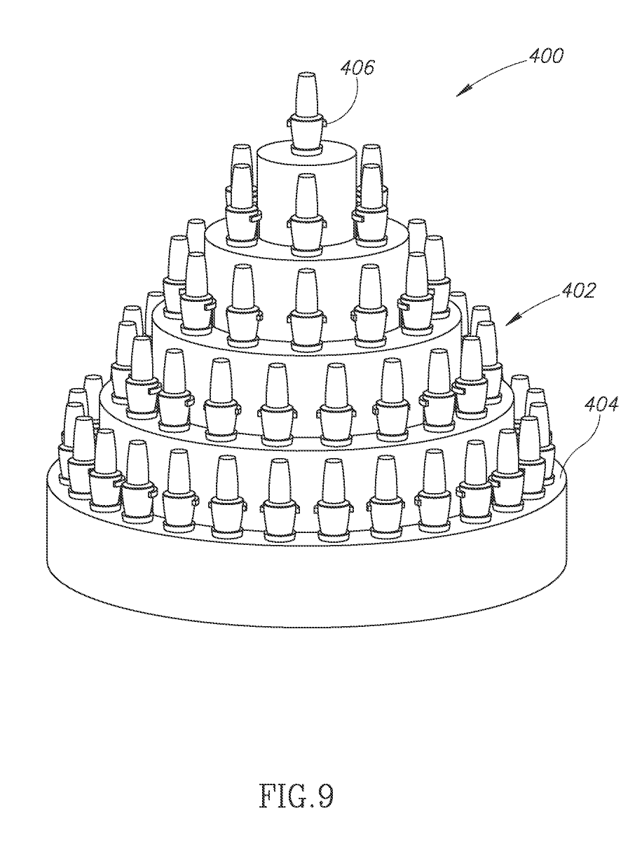

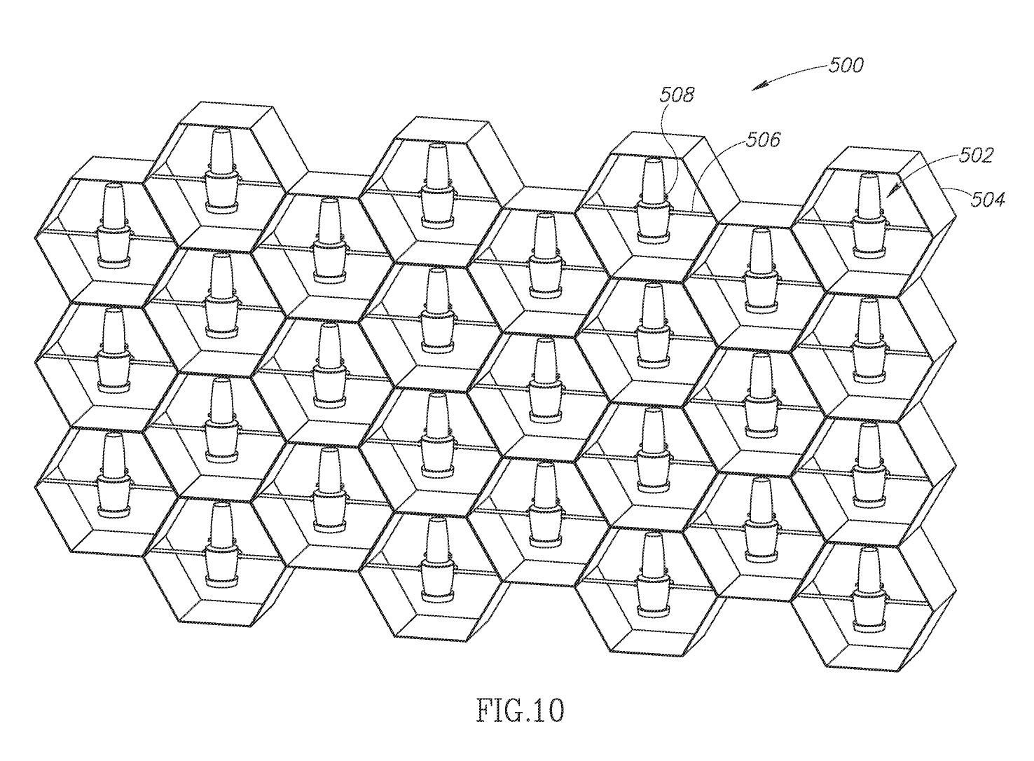

FIG. 5 shows another display system 200 having bottles 202 arranged in a case 204. The display system 200 may include many of the same aspects of the display system 100 as described above, but these same or similar components are not described in detail herein for purposes of brevity and may not be illustrated for purposes of clarity. In the illustrated embodiment, the system 200 includes agitators 206 and bottle-coupling assemblies 208. As best shown in FIG. 6, each bottle-coupling assembly 208 includes a spine member 210 coupled to bottle support members 212 and a leverage member 214, which in turn may be coupled to a base member 216. The bottle support members 212 are configured to closely receive the polish-holding and cap portions, respectively. Moreover, at least one of the bottle support members 212 may provide a clamping action on the bottle 202. The leverage member 214 may be welded, bonded or otherwise attached to the base member 216.

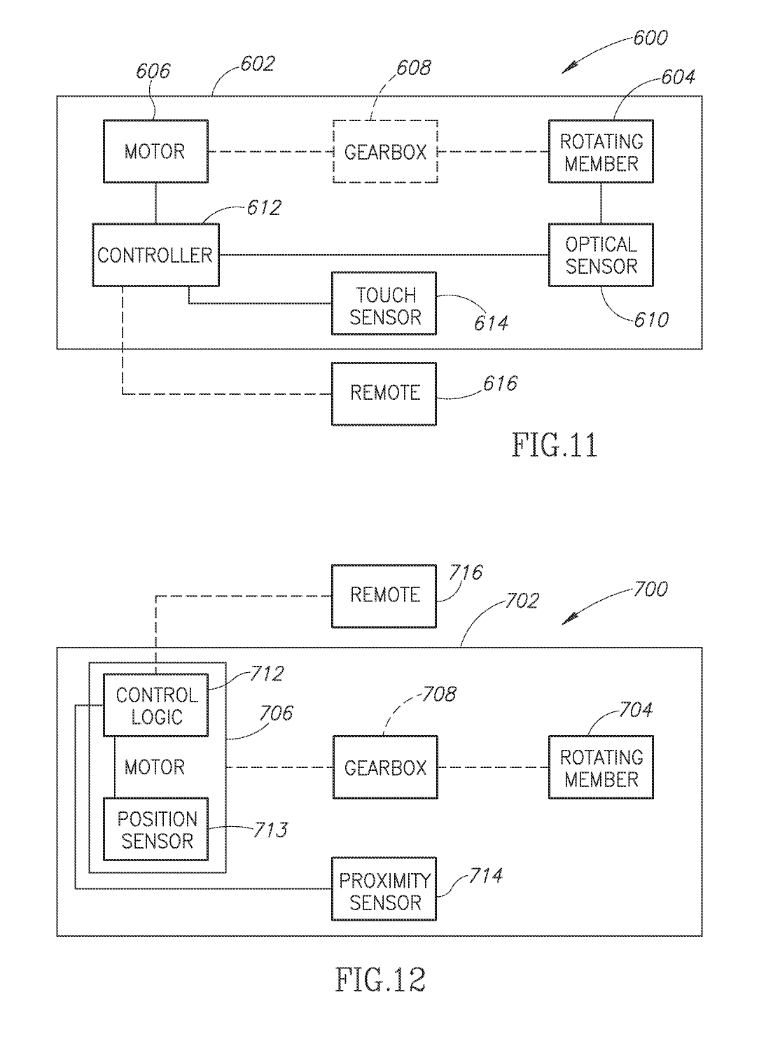

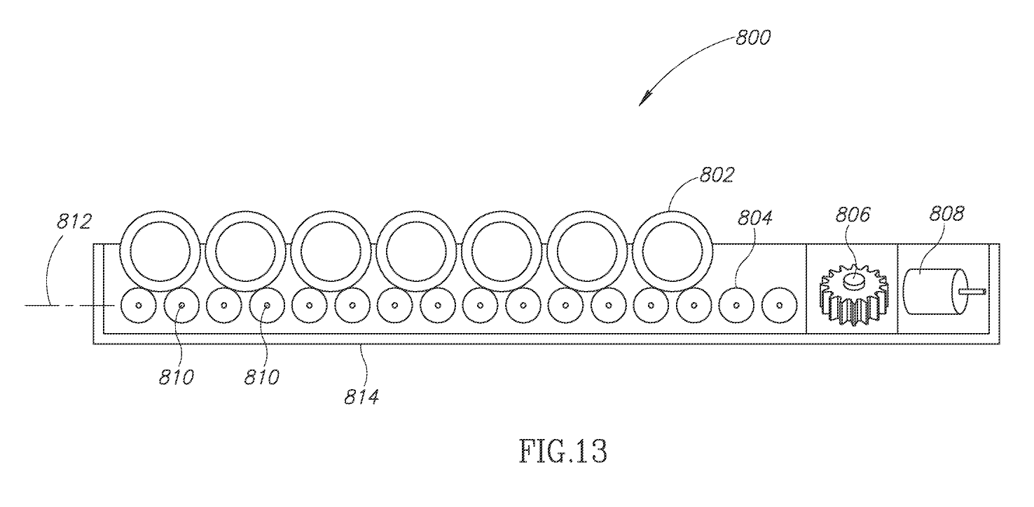

FIGS. 7 and 8 show yet another display system 300 having bottles 302 arranged in a case 304. The display system 300 may include many of the same aspects of the display system 100 as described above, but these same or similar components are not described in detail herein for purposes of brevity and may not be illustrated for purposes of clarity. In the illustrated embodiment, the system 300 includes agitators 306 and bottle-coupling assemblies 308. As best shown in FIG. 8, each bottle-coupling assembly 308 includes a spine member 310 coupled to a bottle support member 312 and to end-cap members 314, 316 (top and bottom, respectively). The bottle support member 312 is configured to closely receive the polish-holding, neck or cap portion of the bottle 302. The spine member 310, bottle support member 312, and end-cap members 314, 316 may take the form of a one-piece component or may be attached together by welding, bonding or some other mechanical process.

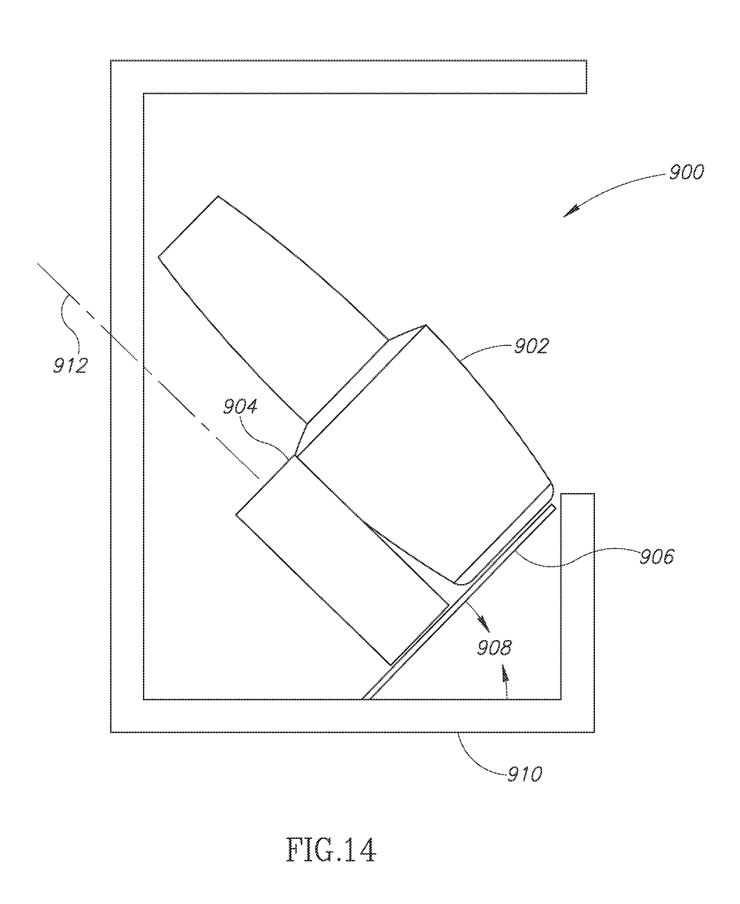

FIG. 9 shows yet another display system 400. In the illustrated embodiment, bottles 402 are arranged on a plurality of tiered surfaces 404. The bottles 402 are held by coupling members 406, which in turn are actuated by agitators (not shown). To mix the polish in the bottles 402, the surfaces 404 may be telescoped such that they may be lowered and then the bottles rotated in either a clockwise or counterclockwise direction. A motor (not shown) for moving the agitators may also be coupled to a gearbox that moves the surfaces 404.

The cases described above may take a variety of forms and shapes, they may be wall mounted or placed on a surface, such as a countertop, desk or floor. The cases may be made out of virtually any material, for example, wood, plastic, metal, etc. In one embodiment, a backing for the case may be a mirrored surface for aesthetic reasons. While the cases may have doors, such doors may take a variety of forms such as hinged doors, sliding doors, etc. A light source such as a light bulb or light emitting diode may be located within the case to provide a desired amount of lighting.

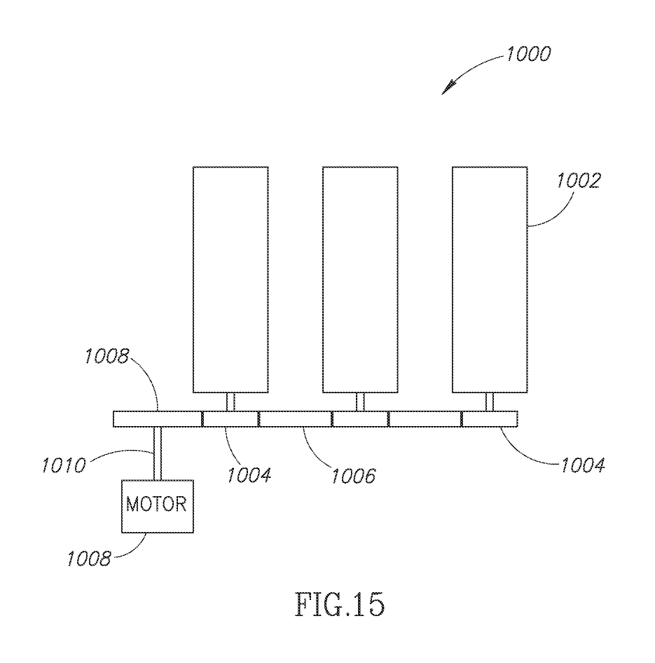

FIG. 10 shows yet another display system 500 in which bottles 502 are coupled to individual cases 504. In turn, the cases 504 may be rotated with the bottles 502 fixed thereto or the bottles 502 may be rotated within each static case 504. The bottles 502 are coupled to the cases 504 using attachment rods 506 in cooperation with coupling devices 508. The shapes and arrangement of the cases 504 may take many forms. Further, the rods 506 may be removable and replaceable and/or interchangeable with different styles, shapes, contours, etc.

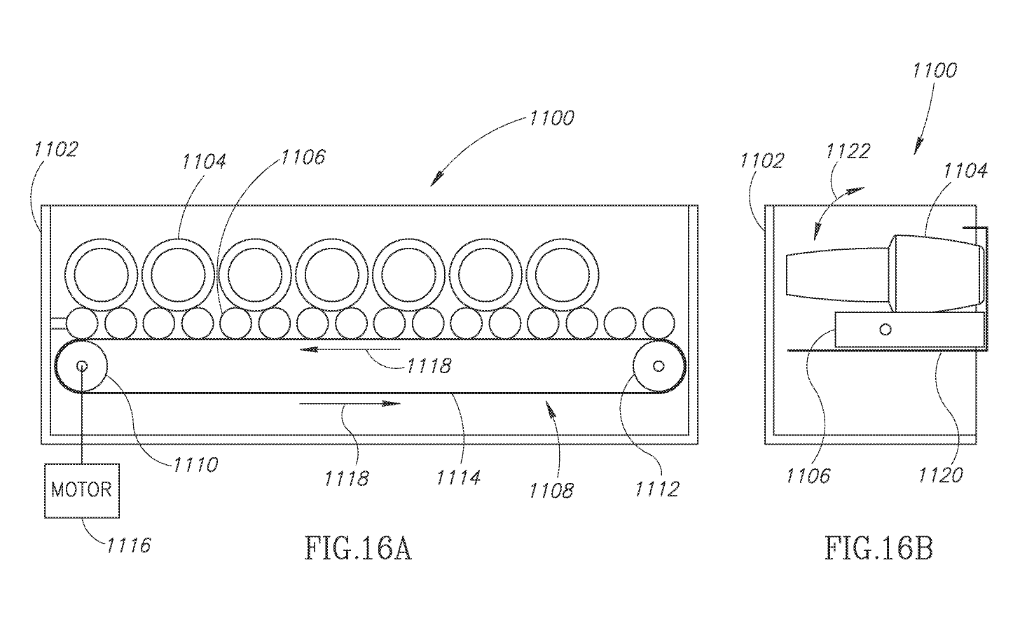

FIG. 11 shows a block diagram 600 of a display system 602. As described above, the display system 602 includes some form of a case with bottles of finger nail polish. By way of example, each bottle is coupled to a rotating member 604, which is moved through operation of a motor 606. Optionally, a gearbox 608 or equivalent mechanism may be employed to reduce, increase or otherwise modify the speed of the rotating member 604. An optical sensor 610 may be positioned to detect a rotational position of the rotating member 604 and this positional information communicated to a controller or microprocessor 612. By knowing the rotational position of the rotating member 604, the motor may be controlled to move the bottles into a desired position and/or orientation when a touch sensor 614 is triggered by a patron or employee.

For example and briefly referring to FIGS. 1 and 11, a patron may trigger the touch sensor 117/614, which in turns provides a signal to the controller/processor 612. The optical sensor 610 correspondingly provides the rotational position of the rotating members 604 to the controller 612, which in turn commands the motor 606 to move the bottles into an uptight position for removal by the patron. Alternatively, the case may be maintained in a locked configuration inaccessible by a patron until an employee commands the case to open using a remote control device 616. So if a patron wants to sample a bottle of nail polish, the employee sends a signal using the remote 616, which opens the case, provides a signal to the controller 612, and consequently operates the motor 606 to move the rotating members 604 into the desired position and/or orientation. In one embodiment, the rotating members 604 may be configured to make the bottles continue to rock slowly rather than come to a complete stop after the touch sensor 614 is triggered.

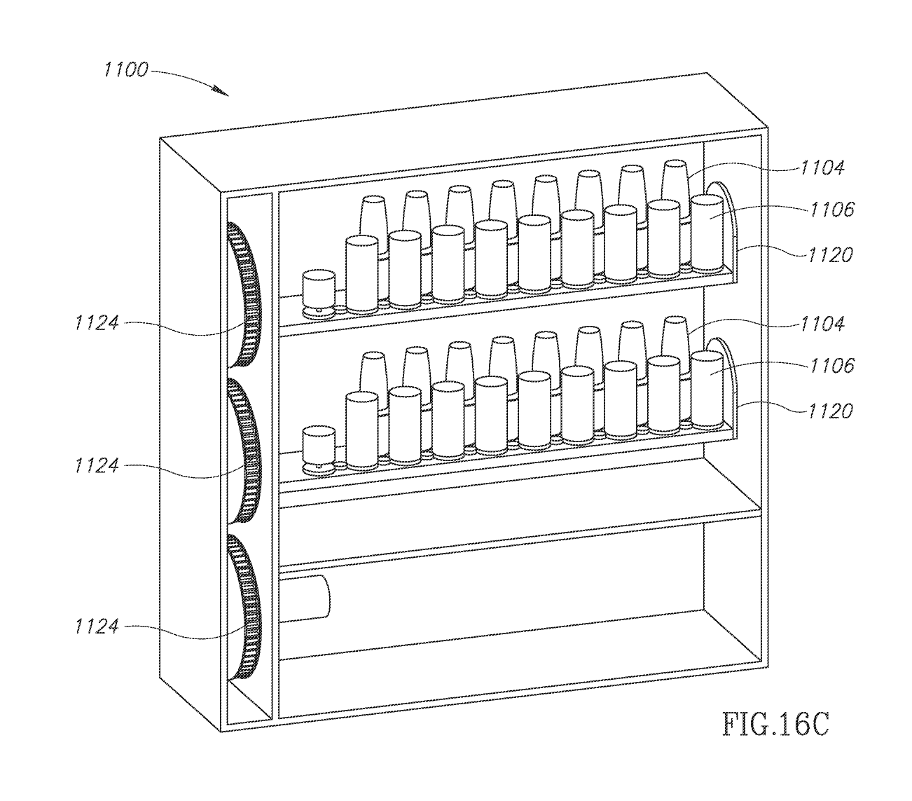

FIG. 12 shows a block diagram 700 of a display system 702. Like components already described, specifically the rotating member 704, the optional gearbox 708, and the remote control device 716, are not be re-described herein. The system 702 includes a proximity sensor 714 to detect a presence of a person near the system 702, for example the presence of a patron ready to open a door on the display case. The proximity sensor 714 may take a variety of forms and may be located in a variety of places on the case. The rotational speed and position of the rotating member 704 is controlled by a motor 706 having motor control logic 712 in cooperation with a position sensor 713. The position sensor 713 determines a rotational position of a motor shaft or some other motor component and then provides this rotational position information to the control logic 712. In one embodiment, the motor 706 takes the form of a stepper motor and operates to quickly rotate the rotating member 704 either clockwise or counterclockwise to position the bottles in the desired position and/or orientation relative to the case.

The inclusion of the motor and controller or control logic permits the bottles to be positioned and oriented in a manner that makes them aesthetically pleasing and readily accessible. The motor may be programmable to modify the agitation speed of the bottles, the rotational direction, etc. The remote can be used to stop the rotation of the bottles from a distance. Alternatively, a sensor may be positioned on the case to detect movement by an interested patron. Upon sensing such movement, the sensor communicates with the controller or control logic, which in turn instructs the motor to stop rotating the bottles so the patron may view and possibly remove the nail polish bottles when they are in an upright position. To prevent the patron from waiting too long, the motor may be commanded to accelerate in the same or reverse direction to orient the bottles within milliseconds of the movement detected by the sensor. In another embodiment, the controller or control logic may include a timing module that instructs the motor to restart after a set period of time. The set period of time may be a certain time after the door to the case has been closed, in which such closure may be detected by a contact sensor, or a certain time after no more movement is detected by the proximity sensor on the case.

While the illustrated embodiments show cases with multiple bottles and rotating members, it is appreciated that the invention may be a case configured to hold and agitate a single bottle. Such a case may be advantageous at a technician's work station or by individuals in their home. While the technician or individual is preparing nails for painting, they can place the nail polish bottle into the case and then allow the bottle to be agitated for an adequate amount of time to sufficiently mix up the polish. Once the polish is mixed, the bottle will stop agitating and the technician/individual will know the polish is now ready for use.

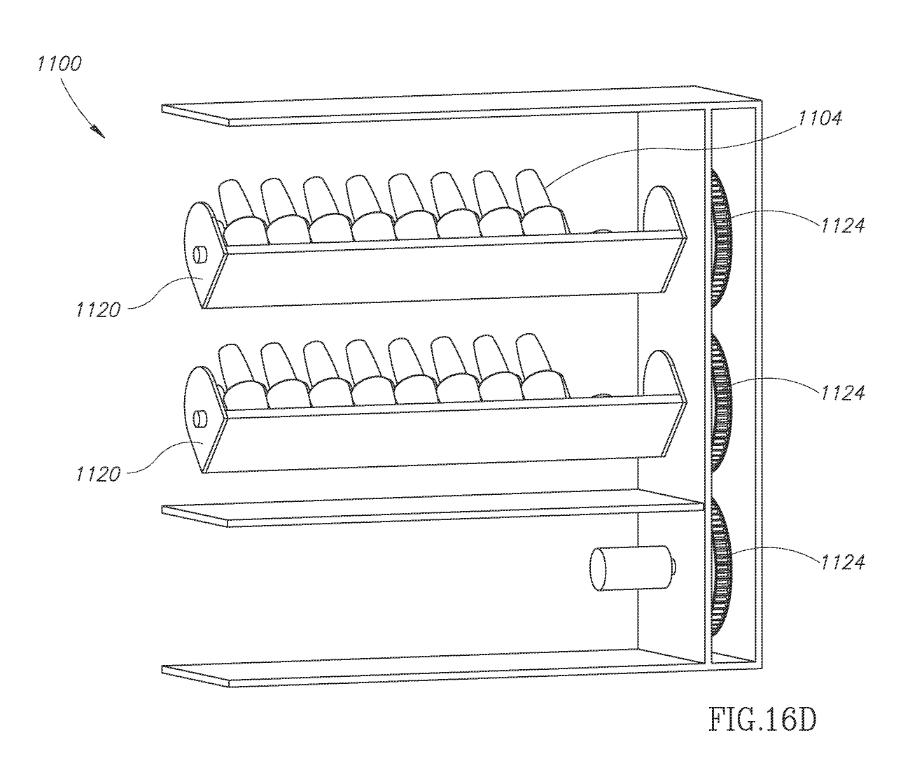

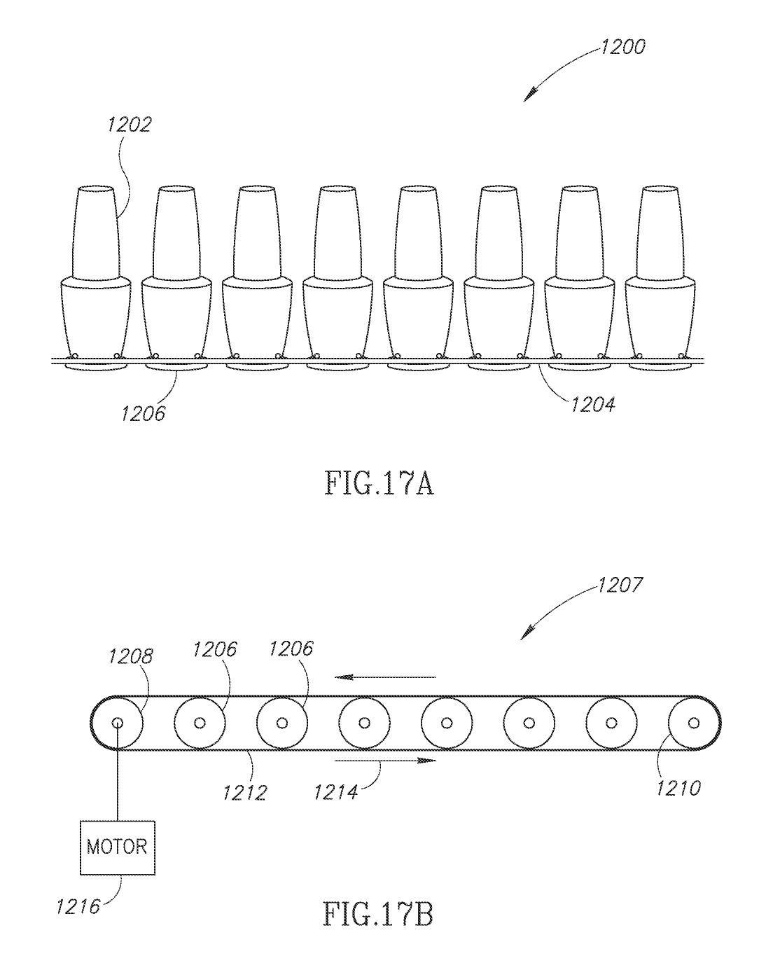

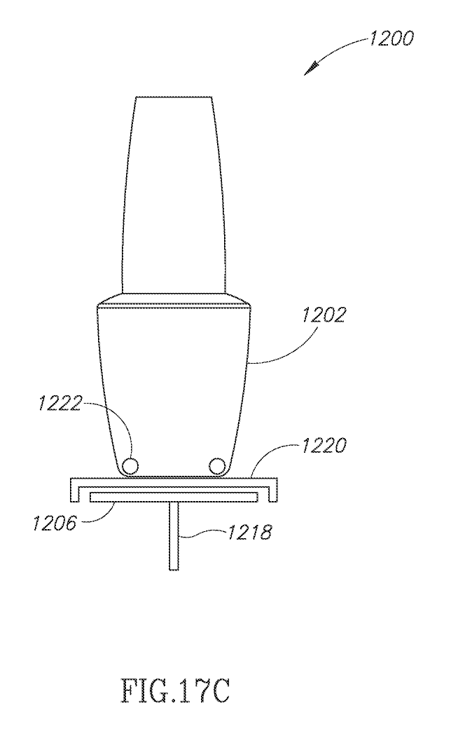

FIG. 13 shows a finger nail polish display system 800 according to another embodiment of the present invention. The display system 800 includes nail polish bottles 802 supported on rollers 804. In particular, one nail polish bottle 802 is support by two adjacent rollers 804. A drive system, not shown in FIG. 13, may include one or more gears 806, powered by a motor 808, which rotationally drives the rollers 804. Preferably all of the rollers 804 may rotate in the same direction, but this is not a requirement because one pair of rollers supporting a single nail polish bottle may rotate in one direction while an adjacent pair of rollers rotates in an opposite direction. The rotational spinning direction of the rollers 804 would depend on the type of drive system used to generate rotation of the rollers. To that end, two different types of drive systems are described in more detail with reference to FIGS. 15-16B below. In the illustrated embodiment, each roller 804 includes a roller axis 810. In turn, the roller axes 804 are aligned in a plane 812, and the plane 812 is substantially parallel to a horizontal surface 814.

Still referring to the illustrated embodiment, the nail polish bottles are lying on their sides and are lined up in the plane 812. As the rollers 804 spin, the nail polish in the bottles 802 becomes continually agitated, and thus remains mixed to the extent that the various components making up the nail polish do not appreciably separate. The system 800 may be powered by a battery or be plugged in to an outlet. The system 800 may have either a manual ON and OFF button or it may have a sensor that would turn off the system 800 when it detects movement nearby, such as a customer or technician opening the display case.

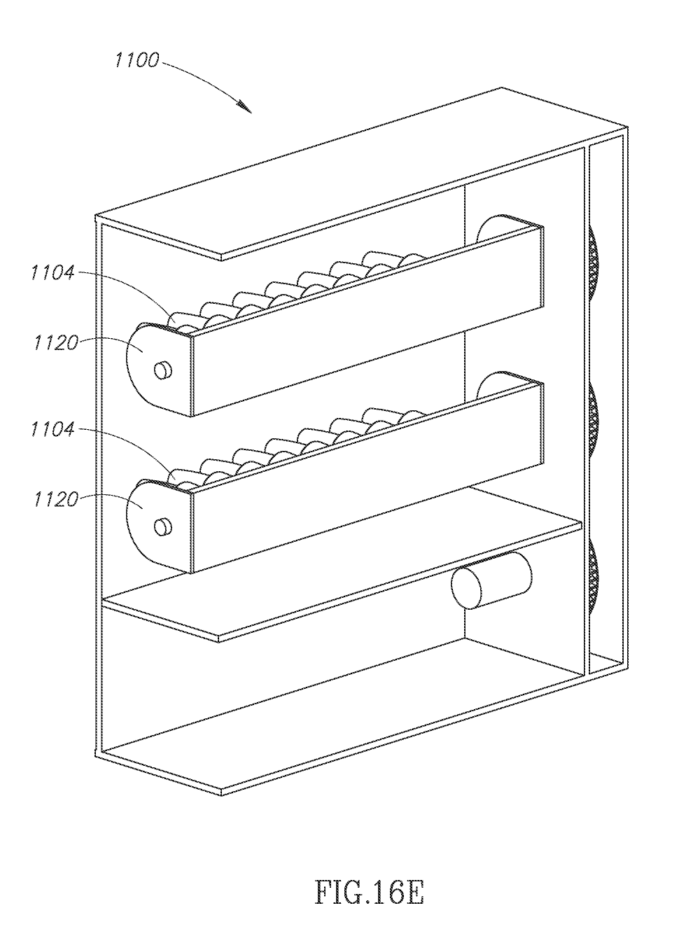

FIG. 14 shows a finger nail polish display system 900 where a nail polish bottle 902 is supported by an angled roller 904 and an angled support member 906. An angle 908 of the support member 906 may vary relative to a horizontal surface 910. In the illustrated embodiment, the support member 906 is angled at about 45 degrees relative to the horizontal surface 910, which in turn permits the nail polish bottle 902 to be displayed and rotated while in an inclined position. Stated otherwise, a plane 912 formed by the rolling axes (not shown) of the rollers 904 would be approximately perpendicular to the support member 906. In one embodiment, the angle 908 of the support member 906 may be adjusted manually or mechanically.

FIG. 15 shows a drive system 1000 for a nail polish display system, such as any of the systems described herein or for other conventional systems. The drive system 1000 includes a plurality of rollers 1002 mechanically coupled to driven gears 1004, respectively. A plurality of idler gears 1006 are positioned between and mesh with respective driven gears 1004, which in turn allows all of the driven gears 1004, and thus the rollers 1002, to rotate in the same direction. At least one of the driven gears 1004 meshes with and is driven by a drive gear 1008, which is mechanically coupled to a motor 1008 using a drive shaft 1010. The motor 1008 may take the form of a reversible motor allowing the rollers 1002 to be rotated in either a clockwise or counterclockwise manner.

FIG. 16A shows a finger nail polish display system 1100 arranged in a case 1102 according to yet another embodiment of the present invention. Similar to FIG. 13, nail polish bottles 1104 lie on rollers 1106, which are driven or rotated by a pulley drive system 1108. A drive pulley 1110, a driven pulley 1112 and a continuous belt 1114 comprise the pulley drive system 1108. A motor 1116 coupled to the drive pulley 1110 dictates which direction 1118 the belt is moved. (i.e., clockwise or counterclockwise as illustrated). The pulley drive system 1108 may be made from lightweight materials to minimize its inertia. In addition, the motor 1116 may be programmable to slowly ramp up or ramp down the speed of the pulley system 1108.

FIGS. 16B, 16C, 16D and 16E show the finger nail polish display system 1100 having a rotatable support 1120 for holding the nail polish bottle 1104 and the roller 1106. The support 1120 may be timed so it tilts 1122 in an upward and/or backward angle during set intervals. One or more gears 1124 are coupled to the supports 1120. Rotation of the gears 1124 causes the support 1120 to rotate or tilt. The tilting movement would cause the balls inside the nail polish bottle 1104 to roll from top to bottom and around inside the bottle 1104, and thus augment the agitation process of the liquid nail polish. FIG. 16C shows the bottles 1104 in an upright configuration. FIG. 16D shows the bottles 1104 at approximately a forty-five degree tilt relative to the horizontal. FIG. 16E shows the bottles 1104 at approximately a ninety degree tilt relative to the horizontal.

In one embodiment, the system 1100 includes a sensor (not shown) that detect nearby movement by a customer or patron. Once movement is detected, the motor 1116 would halt rotation of the rollers 1106 and the support 1120 would be tilted by ninety degrees to bring the nail polish bottles 1104 into an upright position so that customers will he able to choose their desired nail polish color. Once the customer selects their color, the support 1120 would readjust to a horizontal or inclined position and the motor 1116 would recommence spinning of the rollers 1106, which in turn would re-start agitation of the nail polish in the bottles 1104.

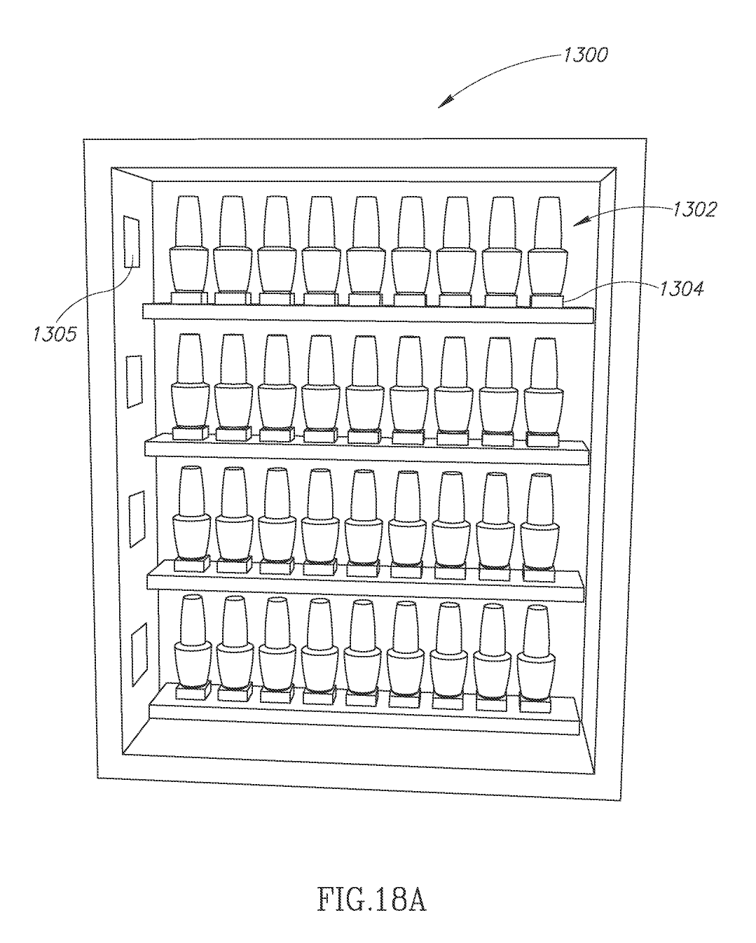

FIGS. 17A and 17B show a nail polish display system 1200 according to another embodiment of the present invention. Nail polish bottles 1202 are fixed to a non-magnetic frame 1204 within the system 1200. Magnetic members 1206 are placed in proximity to a bottom surface of each of the bottles 1202. By way of example, the magnetic members 1206 may take the form of a magnetic disc or a magnetic rod. In addition, the magnetic members 1206 are made from a ferromagnetic material. In FIG. 17B, the magnetic members 1206 are driven by a pulley system 1207 having a drive pulley 1208, an idler pulley 1210 and a continuous drive belt 1212. In the embodiment where the magnetic members 1206 are disc-shaped, the belt 1212 contacts the tangential surfaces of the magnetic members 1206 causing them to rotate. In turn, the rotating magnetic member 1206 causes at least one ferromagnetic ball 1222 (see FIG. 17C) to move relative to the liquid nail polish and thus agitate the polish accordingly. A belt direction 1214 determines a spin direction for the magnetic members 1206. A motor 1216 coupled to the drive pulley 1208 may be driven in opposite directions to correspondingly rotated the magnetic members 1206 either clockwise or counterclockwise.

FIG. 17C shows the system 1200 in which the nail polish bottle 1202 is supported on a thin, non-magnetic, static platform 1220. The magnetic disc 1206 is coupled to a shaft or connecting rod 218, which in turn may be coupled to a gear train such as, but not limited to, the year train drive system from FIG. 15. The movement of the magnetic disc 1206 would cause the ferromagnetic balls 1222 inside the bottle 1202 to agitate the liquid nail polish.

Conventional nail polish bottles typically contain small metallic balls that agitate the liquid nail polish when the bottle is shaken. In the event that a bottle does not contain a metallic ball, the retailer (e.g., nail salon) may insert the ball themselves.

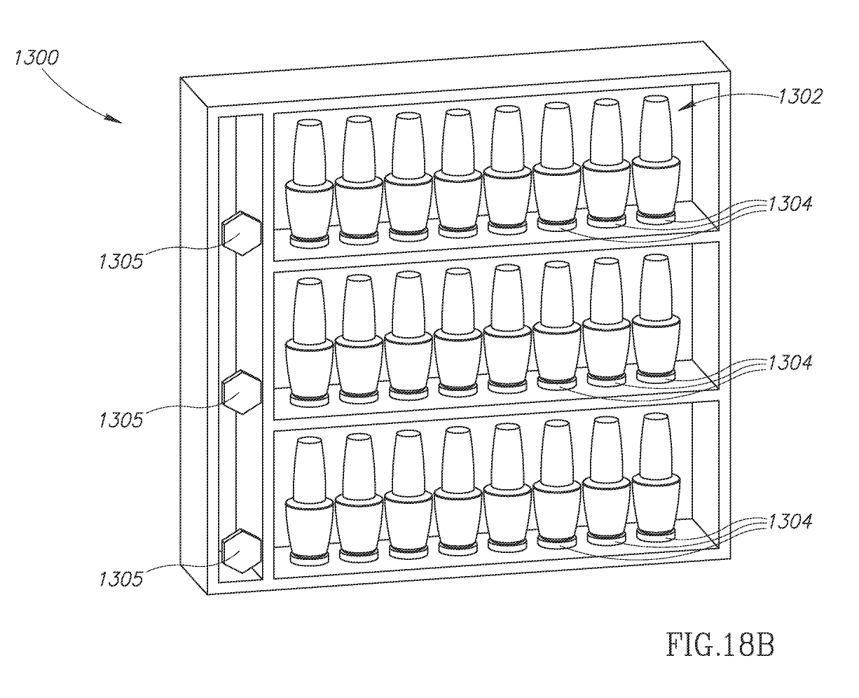

FIGS. 18A and 18B show yet another display system 1300 in which nail polish bottles 1302 are supported on vibrating pads or supports 1304. The pads 1304 may take the form of transducers (e.g., quartz or ceramic crystal) that may be controlled to vibrate at a predefined frequency selected to achieve a sufficient amount of agitation of the nail polish. The vibrations may be created electronically, by passing alternating current through a quartz or ceramic crystal, mechanically with special sirens, or magnetically by the action of an alternating magnetic field on a hollow metal rod. In one embodiment, ultrasonic generators 1305 power the transducers 1304 with electrical oscillations at a frequency that outside of an audible frequency range (e.g., an ultrasonic frequency of about 19 kHz). The frequency provide electrical energy to the transducers, which in turn is then converted into sounds waves by the transducers, which makes the pads 1304 vibrate.

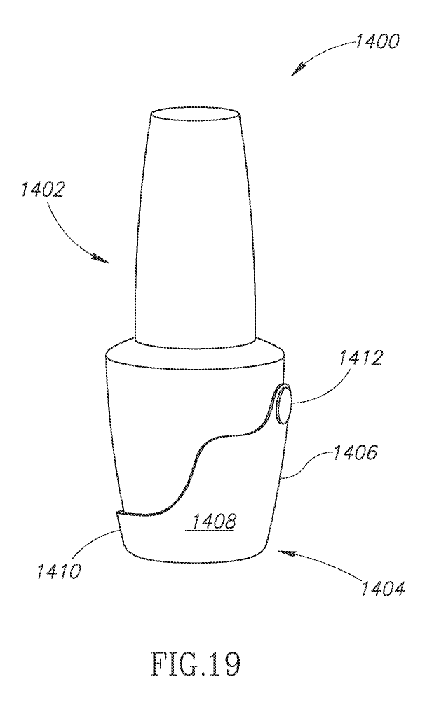

FIG. 19 shows a. nail polish bottle system 1400 in which a nail polish bottle 1402 is closely received in a contoured sleeve 1404. In one embodiment, the sleeve 1404 includes a back portion 1406, side portions 1408 and a front portion 1410. The back portion 1406 covers a majority of a backside of the bottle 1402. The side portions 1408 operate to form a contoured transition from the back portion 1408 to the front portion 1410. The front portion 410 covers only a small region of a front of the nail polish bottle 1402, thus leaving a majority of the bottle clearly visible so that a customer or technician may quickly determine a brand and/or color of the nail polish bottle 1402. The back, side and front portions are configured to define a cavity that closely receives the nail polish bottle 1402. In one embodiment, the back and side portions may be expandable to closely receive the bottle 1402.

In one embodiment, the sleeve 1404 takes the form of a protective sleeve made from a shock absorbent material such as, but not limited to a foam material, a polymeric material, a rubber material, etc. In operation, the sleeve 1404 holds the nail polish bottle 1402 while it is on display and would continue to be connected to the nail polish bottle 1402 even when taken out of the display case. The configuration of the sleeve 1404 and the type of material chosen for the sleeve 1404 operates to protect the bottle against breakage if dropped. Currently, in the market, there are no products that would help to prevent the nail polish bottle from breaking when it is dropped. While there are too many variables that can affect the breakage of the bottle, it is appreciated that the sleeve 1404 simply helps reduce the likelihood that the bottle will break.

While the preferred embodiments of the invention have been illustrated and described, as noted above, many changes can be made without departing from the spirit and scope of the invention. Accordingly, the scope of the invention is not limited by the disclosure of the preferred embodiments. Instead, the invention should be determined entirely by reference to the claims that follow.

1. A nail polish display system comprising:
a plurality of rollers arranged adjacently to one another, each roller having a rolling axis, Wherein the rolling axes form a plane, and at least one nail polish bottle contacts two of the rollers;
a drive system arranged to rotate the plurality of rollers; and
a motor coupled to the drive system, wherein operation of the motor and drive system causes rotation of the rollers, which in turn agitates nail polish within the at least one nail polish bottle.

2. The nail polish display system of claim 1, wherein the plane formed by the rolling axes is substantially parallel to a horizontal surface.

3. The nail polish display system of claim 1, wherein the plane formed by the rolling axes is angled relative to a horizontal surface.

4. The nail polish display system of claim 1, wherein the drive system includes a pulley system having at least two pulleys and a continuous drive belt.

5. The nail polish display system of claim 1, wherein the drive system includes a drive gear coupled to the motor, the drive gear configured to rotate as first gear of a plurality of gears, wherein at least some of the plurality of gears are coupled to respective rollers.

6. The nail polish display system of claim 1, wherein the motor is a reversible motor.

7. The nail polish display system of claim 1, further comprising a programmable controller in communication with the motor.

8. The nail polish display system of claim 4, wherein the programmable controller instructs the motor to rotate the drive system at a desired rotational velocity sufficient to agitate the nail polish.

9. The nail polish display system of claim 4, wherein the programmable controllable is configurable to halt rotation of the drive system upon receiving a signal.

10. The nail polish display system of claim 1, further comprising a sensor in signal communication with the motor.

11. The nail polish display system of claim 1, wherein the sensor is a motion sensor positioned to detect motion near the display system.

12. The nail polish display system of claim 1, wherein the sensor is a touch sensor positioned on the display system.

13. A nail polish display system comprising:
a nail polish bottle having a ball located within the bottle, the ball made from a ferromagnetic material;
a non-magnetic support surface in contact with a bottom surface of the nail polish bottle;
a rotatable ferromagnetic member located beneath the support surface;
a drive system coupled to the ferromagnetic member; and
a motor coupled to the drive system, wherein operation of the motor and drive system causes rotation of the ferromagnetic member, which in turn moves the ball within the bottle to agitate the nail polish.

14. The nail polish display system of claim 13, wherein the rotatable ferromagnetic member is a disc.

15. The nail polish display system of claim 13, wherein the rotatable ferromagnetic member is a rod.

16. The nail polish display system of claim 13, wherein the drive system is a pulley drive system.

17. A nail polish display system comprising:
a nail polish bottle;
a vibration generation device configured to transmit a non-audible frequency signal;
a support member located in contact with the nail polish bottle; and
a transducer configured to receive the non-audible frequency signal and vibrate the support member, the transducer coupled to or enclosed within the support member.

18. The nail polish display system of claim 17, wherein the non-audible frequency signal is an ultrasonic frequency signal.

19. The nail polish display system of claim 17, wherein the transducer is a quartz crystal located within the support member.

20. The nail polish display system of claim 17, wherein the transducer is a ceramic crystal located within the support member.

21. A protective sleeve for a nail polish bottle, the sleeve comprising:
a back portion substantially covering a majority of a back side of the nail polish bottle;
side portions extending around each side of the nail polish bottle; and
a front portion extending between the side portions, the front portion configured to permit nearly a full view of the nail polish bottle;
wherein the back, side and front portions are configured to define a cavity that closely receives the nail polish bottle.

22. The protective sleeve of claim 21, further comprising an attachment device located on the back portion, the attachment device configured to secure the nail polish bottle within a display case.

23. The protective sleeve of claim 21, wherein the attachment device is a tab made from a ferromagnetic material.

24. The protective sleeve of claim 21, wherein the protective sleeve is made from a shock absorbent material.

25. The protective sleeve of claim 21, wherein the back and side portions are expandable to closely receive the nail polish bottle.
